(19) United States
(12) Patent Application Publication
(10) Pub. No.: US 2026/0180508 A1
(43) Pub. Date: Jun. 25, 2026

(54) DIFFERENTIAL AND SINGLE-ENDED RELAXATION OSCILLATORS FOR PHYSICAL UNCLONABLE FUNCTION (PUF) CIRCUITS AND FOR PROVIDING CLOCKS TO MULTIPLE DIES

(71) Applicants: XILINX, INC., San Jose, CA (US); ATI Technologies ULC, Markham (CA)

(72) Inventors: Shadi BARAKAT, Redwood City, CA (US); Chi Ho LAW, San Jose, CA (US); Aswani Aditya Kumar TADINADA, Hyderabad (IN); Gautham Srikanth JAMI, Markham (CA); Vasu BEVARA, Hyderabad (IN); Venkatasuryam Setty ISSA, Hyderabad (IN)

(21) Appl. No.: 18/988,385

(22) Filed: Dec. 19, 2024

(51) Int. Cl. H03B 5/24; H03K 3/3565; H04L 9/32

(52) U.S. Cl. CPC H03B 5/24; H03K 3/3565; H04L 9/3278

(57) ABSTRACT

Embodiments herein describe relaxation oscillator circuits for physical unclonable function (PUF) circuits and/or for providing clocks to multiple dies. The relaxation oscillator circuit generates a clock having a frequency that is based in part on random process variations of the passive components of the relaxation oscillator circuit. The relaxation oscillator circuit may be distributed amongst multiple dies of an integrated circuit device, to incorporate additional sources of randomness/entropy, enhance security, to provide clocks to the multiple dies. The relaxation oscillator circuits include differential and single-ended relaxation oscillator circuits. Resistive and/or capacitive components may be configurable, which may be useful for testing purposes, altering PUF codes, and/or generating time-multiplexed clocks.

### TECHNICAL FIELD

Examples of the present disclosure generally relate to differential and single-ended relaxation oscillators for physical unclonable function (PUF) circuits and for providing clocks to multiple dies.

### BACKGROUND

A physical unclonable function (PUF) circuit generates a signature (e.g., a sequence of bits) that is unique to the PUF circuit, based on random process variations (i.e., random variations in a fabrication process). The random process variations serve as sources of entropy/randomness that are unique to the PUF circuit. PUF circuits are used in security applications, such as authentication of devices in which the PUF circuits are embedded.

The random process variations may be independent and uncorrelated across devices and/or within a device. Examples of random process variation include, without limitation, dopant fluctuation, line-edge roughness, and random telegraph noise. Random process variation may be more pronounced at smaller process scales, where variations become a larger percentage of lengths/widths of devices.

### SUMMARY

Techniques for differential and single-ended relaxation oscillators for a physical unclonable function (PUF) circuits and for providing clocks to multiple dies are described. One example is an integrated circuit device that includes a physical unclonable function (PUF) circuit having a relaxation oscillator circuit that generates a clock with a frequency and/or phase that is based on random process variations of the PUF circuit, where at least a portion of the relaxation oscillator circuit is distributed amongst multiple dies of the integrated circuit device.

The relaxation oscillator circuit may include a differential relaxation oscillator circuit or a single-ended relaxation oscillator. The PUF circuit may further include configurable circuitry (e.g., resistive and/or capacitive components) to control a frequency and/or phase of the clock. The PUF circuit may further include control circuitry to configure the configurable circuitry. The differential oscillator circuit may be placed within a first one of the dies (e.g., a lowest-most die), and the configurable circuitry may be distributed amongst multiple dies (e.g., the lowest-most die and an upper-most die). The control circuitry may be placed in the first die or may be distributed amongst the multiple dies.

Another example described herein is an integrated circuit device that includes a clock generator circuit that includes a relaxation oscillator circuit having a resistor circuit and a capacitor circuit, where one or more of the resistor circuit and the capacitor circuit is distributed amongst multiple dies of the integrated circuit device. The resistor circuit and/or the capacitor circuit may be configurable, which may permit a clock frequency and/or phase to be controlled/altered based on values and locations of resistor and/or capacitor components across a die stack.

Another example described herein is a method that includes enabling a clock generator circuit that includes a relaxation oscillator circuit in a first one of multiple dies of an integrated circuit device, and a resistive/capacitive (RC) circuit distributed amongst the multiple dies, where the RC circuit is configurable in first and second configurations to provide respective first and second RC time constants. The method further includes configuring the RC circuit in the first configuration for a first period of time and configuring the RC circuit in the second configuration for a second period of time such that the clock generator circuit generates a clock signal with first and second time-multiplexed frequencies that are based in part on the respective first and second RC time constants.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 depicts a physical unclonable function (PUF) circuit that includes a relaxation oscillator circuit, according to an embodiment.

FIG. 2 depicts a periodic clock generated by the PUF circuit of FIG. 1, according to an embodiment.

FIG. 3 depicts charging signal generated by the relaxation oscillator circuit, according to an embodiment.

FIG. 4 depicts a system that includes a PUF circuit having multiple relaxation oscillator circuits, according to an embodiment.

FIG. 5 depicts a differential relaxation oscillator circuit, according to an embodiment.

FIG. 6 depicts a splintered/distributed implementation of the differential relaxation oscillator circuit, according to an embodiment.

FIG. 7 depicts another splintered/distributed implementation of the differential relaxation oscillator circuit, according to an embodiment.

FIG. 8 depicts another splintered/distributed implementation of the differential relaxation oscillator circuit, according to an embodiment.

FIG. 9 depicts a single-ended relaxation oscillator circuit, according to an embodiment.

FIG. 10 depicts the single-ended relaxation oscillator circuit of FIG. 9, according to an embodiment.

FIG. 11A depicts a splintered/distributed implementation of the single-ended relaxation oscillator circuit of FIG. 9, according to an embodiment.

FIG. 11B depicts an equivalent schematic of the splintered/distributed single-ended relaxation oscillator circuit of FIG. 11A, in a first configuration, according to an embodiment.

FIG. 11C depicts an equivalent schematic of the splintered/distributed single-ended relaxation oscillator circuit of FIG. 11A,, in a second configuration, according to an embodiment.

FIG. 11D depicts a method of generating a clock having time-multiplexed frequencies, according to an embodiment.

FIG. 11E depicts a system that includes a physical unclonable function (PUF) circuit having multiple splintered/distributed single-ended relaxation oscillator circuits, according to an embodiment.

FIG. 12 depicts a system that includes a single-ended relaxation oscillator circuit, according to an embodiment.

FIG. 13 depicts the system of FIG. 12, according to an embodiment.

FIG. 14 depicts a single-ended relaxation oscillator circuit operating on supply-independent bias, according to an embodiment.

FIG. 15 depicts a multi-die integrated circuit device in which a PUF circuit, as disclosed herein, may be implemented.

FIG. 16 depicts another multi-die integrated circuit device in which a PUF circuit, as disclosed herein, may be implemented.

FIG. 17 depicts another multi-die integrated circuit device in which a PUF circuit, as disclosed herein, may be implemented.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe differential and single-ended relaxation oscillators for physical unclonable function (PUF) circuits and for providing clocks to multiple dies. A relaxation oscillator is a nonlinear electronic oscillator circuit that generates a periodic charging signal by repeatedly charging a charge storage circuit (e.g., a capacitive and/or inductive charge storage circuit) through a resistance, and discharging the charge storage circuit when the charge reaches a threshold, and generates a non-sinusoidal clock repetitive output signal (e.g., a clock), such as a triangle wave or square wave, based on the charging signal.

A relaxation oscillator circuit, as disclosed herein, generates a clock having a frequency that is based in part on random process variations of the relaxation oscillator circuit and associated circuit elements/components. Sources of randomness/entropy may be a function of CMOS process passive elements, such as resistors, capacitors, and/or inductors, and/or CMOS process active elements, such as MOS transistors/current sources and/or other elements. A relaxation oscillator circuit, as disclosed herein, may be distributed/splintered amongst multiple regions of a die (e.g., to incorporate additional sources of randomness/entropy and/or enhance security), and/or amongst multiple dies (e.g., to provide clocks to the multiple dies). Resistive, capacitive, and/or inductive components may be configurable, which may be useful for testing purposes and/or for altering PUF codes. Configurability of a splintered relaxation oscillator may be useful to control a division of entropy contributions across multiple regions of a die and/or across multiple dies. A splintered relaxation oscillator circuit may incorporate features within an upper-most layer/die, which may enhance security, in that removal or tampering of the upper-most layer/die disables the relaxation oscillator or corrupts the randomness entropy generation function.

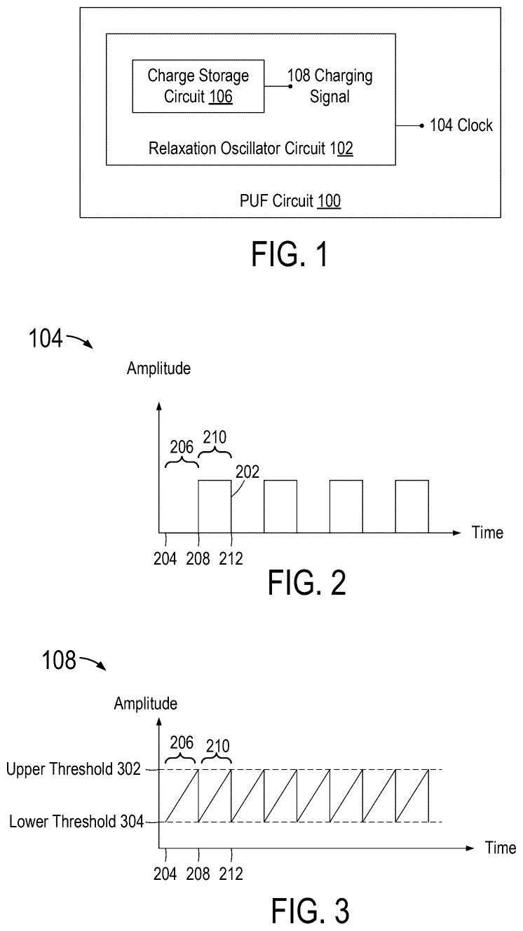

FIG. 1 depicts a physical unclonable function (PUF) circuit 100 that includes a relaxation oscillator circuit 102, according to an embodiment. Relaxation oscillator circuit 102 is a nonlinear electronic oscillator circuit that generates a non-sinusoidal periodic output signal, depicted here as a clock 104. Clock 104 may include periodic pulses, a triangle wave, and/or a square wave. FIG. 2 depicts clock 104, according to an embodiment. Clock 104 is not limited to the example of FIG. 2.

Relaxation oscillator circuit 102 may include charge storage circuit 106 that repeatedly charges and discharges (i.e., relaxes) to provide a periodic charging signal 108, and relaxation oscillator circuit 102 may generate clock 104 based on charging signal 108. Charge storage circuit 106 may include, for example and without limitation, a resistor circuit in combination with a capacitive and/or inductive circuit.

FIG. 3 depicts charging signal 108, according to an embodiment. Charging signal 108 is not limited to the example of FIG. 3. When charging signal 108 reaches an upper threshold 302, relaxation oscillator circuit 102 generates a pulse 202, and charge storage circuit 106 is discharged. Charge storage circuit 106 may be discharged to a lower threshold 304. In an example, upper threshold 302 equals a supply voltage of PUF circuit 100, and lower threshold 304 equals to reference voltage (e.g., ground), of PUF circuit 100. In other examples, upper threshold 302 is less than a supply voltage, and/or lower threshold 304 is above the reference voltage.

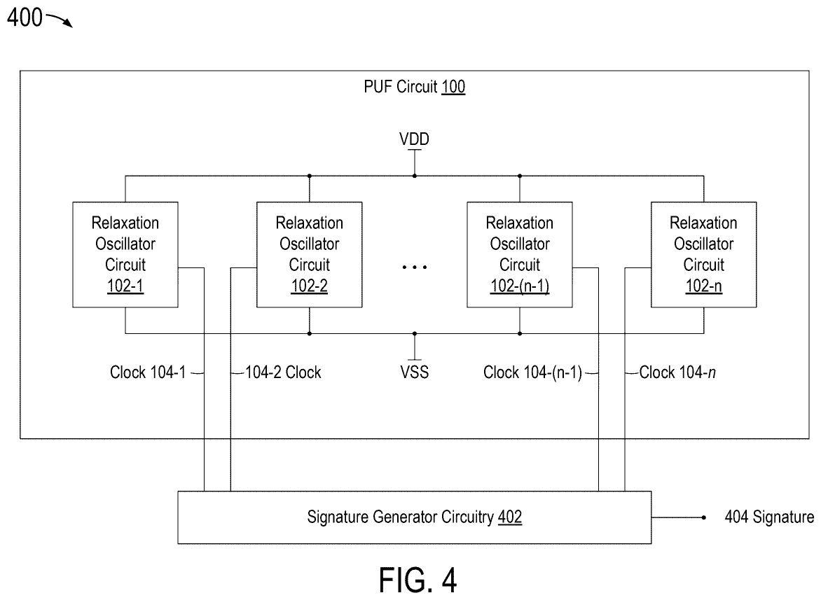

PUF circuit 100 may include multiple instances of relaxation oscillator circuit 102, such as described below with reference to FIG. 4. FIG. 4 depicts a system 400 that includes PUF circuit 100, with n relaxation oscillator circuits 102-1 through 102n, according to an embodiment. Relaxation oscillator circuits 102-1 through 102-n generate respective clocks 104-1 through 104-n. Relaxation oscillator circuits 102-1 through 102-n may be designed to generate clocks 104-1 through 104-n with identical frequencies but, due to random process variations, frequencies of pairs of clocks 104-1 through 104-n may differ from one another, in a random fashion depending on process variations of a resistor or/and capacitor or/and other circuit elements of the oscillator. As an example, clock 104-1 may be faster or slower than clock 104-2.

System 400 further includes signature generator circuitry 402 that compares pairs of clocks 104-1 through 104-n to one another, and generates a bit value (e.g., a logic one or a logic zero) for each pair of clocks depending upon a frequency difference between the pair of clocks. As an example, if clock 104-1 is slightly faster than clock 104-2, signature generator circuitry 402 may generate a bit value of one. In an example, n=512, and signature generator circuitry 402 generates a 256-bit signature 404 that is unique to PUF circuit 100. System 400 is not limited to 256-bit signatures or binary values. In another example, signature generator circuitry 402 generates signature 404 based on a logical and/or mathematical function of the frequency difference between pairs of relaxation oscillators. In another example, signature generator circuitry 402 generates signature 404 as a 512-bit (or other numbers of bits) signature from n=512 by changing the configurable resistor/capacitor/other circuit elements.

Signature 404 may be useful to authenticate PUF circuit 100 and/or to authenticate a device in which PUF circuit 100 is embedded. In an example, system 400 may be embedded within an integrated circuit device, and signature 404 may be provided to a signature authentication system for authentication of the integrated circuit device. The signature authentication system may be external of the integrated circuit device (e.g., within a host device and/or a network-connected device), or may be internal to the integrated circuit device (e.g., a platform management controller and/or a trusted execution unit). In another example, system 400 may be embedded within a user device, such as a smart phone or an Internet-of-Things (IoT) device, and signature generator circuitry 402 may provide signature 404 to a management system/server (e.g., via the Internet) for authentication of the user device.

Example embodiments of relaxation oscillator circuit 102 are provided further below, including single-ended and differential relaxation oscillator circuits. PUF circuit 100 and/or relaxation oscillator circuit 102 may be splintered or distributed amongst multiple regions (e.g., layers, levels, and/or locations) of one or more integrated circuit dies (e.g., a 2D and/or a 3D device). Splintering PUF circuit 100 may be useful to provide additional sources of entropy and/or to enhance security, examples of which are provided further below.

Relaxation oscillator circuit 102 may be used for non-PUF circuit applications. As an example, a splintered relaxation oscillator circuit 102 may be useful to generate clock signals for multiple dies of a multi-die integrated circuit device.

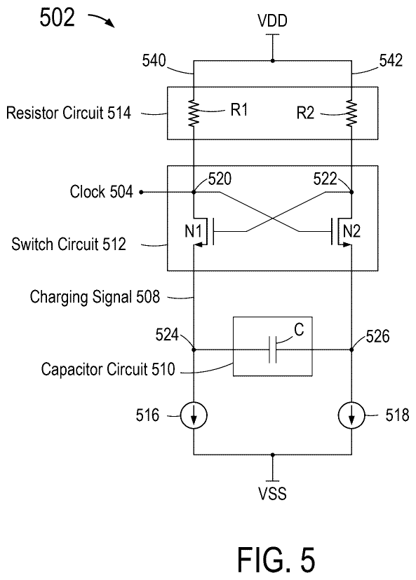

FIG. 5 depicts a differential relaxation oscillator circuit 502, according to an embodiment. Differential relaxation oscillator circuit 502 may represent an example embodiment of relaxation oscillator circuit 102. Relaxation oscillator circuit 102 is not limited to the example of FIG. 5. Differential relaxation oscillator circuit 502 may enhance immunity to noise and/or other power supply effects, and may reduce/eliminate concerns regarding AC/DC noise in a 3D device (i.e., multiple stacked dies).

Differential relaxation oscillator circuit 502 includes paths 540 and 542, a capacitor circuit 510. Differential relaxation oscillator circuit 502 further includes a resistor circuit 514, a switch circuit 512, a capacitor circuit 510, and devices 516 and 519. Resistor circuit 514 provides power to switch circuit 512, switch circuit 512 charges capacitor circuit 510, and devices 516 and 518 discharge capacitor circuit 510, in an alternating fashion. A rate at which capacitor circuit 510 is charged and discharged determines the oscillating frequency of clock 504. Devices 516 and 518 may include current sources, which may include transistors/current mirrors biased with a bias voltage or a bias current.

In FIG. 5, resistor circuit 514 includes resistor circuits R1 and R2. Switch circuit 506 includes cross-coupled transistors, depicted here as N-type transistors, N1 and N2. When VDD is applied to paths 540 and 542, current flows through resistors R1 and R2 to provide voltages V1 and V2 at respective nodes 520 and 522 (i.e., drains and gates of transistors N1 and N2). In this situation, N1 and N2 begin to turn on (i.e., to begin conducting current from the drains to the sources). When current flows through transistors N1 and N2, resistors R1 and R2 provide voltages at respective nodes 524 and 526.

Resistors circuits R1 and R2 may be designed to have identical resistances, transistors N1 and N2 may be designed to have identical voltage thresholds, and devices 516 and 518 may be designed to have identical currents, such that the voltages at nodes 524 and 528 should be identical to one another. Due to random process variations, however, resistor circuits R1 and R2 may differ from one another, voltage thresholds of transistors N1 and N2 may differ from one another, and/or currents of devices 516 and 518 may differ from one another. In this situation, current flow through transistors N1 and N2 may differ from one another.

In an example, more current initially flows through transistor N1. In this situation, the voltage at node 520 (i.e., at the drain of N1 and the gate of transistor N2) falls toward a voltage of node 524 faster than the voltage at node 522 falls towards a voltage of node 526. As the voltage at node 520 (i.e., the gate of transistor N2) falls, current flow through transistor N2 is restricted, which increases the voltage at node 522 (i.e., the drain of transistor N2 and the gate of transistor N1). The net effect is that N1 turns fully on (i.e., saturation/linear), and N2 is fully off (non-conducting). In this state, node 520 (i.e., clock 504) is pulled down to the voltage of node 524, depicted at time 204 in FIG. 2. Further in this state, node 526 is pulled down towards VSS via device 518. The voltage difference between nodes 524 and 526 charges capacitor circuit 510 over time 206 in FIGS. 2 and 3.

As capacitor circuit 510 charges, the voltage at node 524 increases. When the voltage at node 524 reaches upper threshold 302 (FIG. 3), N1 turns-off. In the example of FIG. 5, upper threshold 302 may correspond to threshold voltages (i.e., a gate-to-source voltages) of transistors N1 and N2. When transistor N1 turns-off, the voltage and node 524 is pulled downward toward VSS, capacitor circuit 510 discharges via device 516, and node 520 (i.e., clock 504) returns to voltage V1, as depicted at time 208 in FIG. 2.

When the voltage at node 520 (i.e., the gate of transistor N2) returns to V1, N2 turns on, which charges capacitor circuit 510 in the opposite direction/polarity, over time 210 in FIGS. 2 and 3. When the voltage at node 526 reaches upper threshold 302, transistor N2 turns-off. When transistor N2 turns-off, node 526 is pulled down towards VSS via device 518, capacitor circuit 510 discharges via device 518, and node 522 returns to voltage V2. When node 522 returns to voltage V2, N1 turns on and the voltage at node 520 (i.e., clock 504) is pulled down via transistor N1, as depicted at time 212 in FIG. 2.

The foregoing process repeats as long as VDD is connected. Where differential relaxation oscillator circuit 502 is used in a PUF circuit, differential relaxation oscillator circuit 502 may further include power control circuit that provides VDD during a power-on phase to generate a signature (e.g., signature 404 in FIG. 4), and that disables VDD subsequent to signature generation (e.g., to reduce power consumption).

The frequency of clock 504 is based on a resistive/capacitive (RC) time constant of capacitor circuit 510 and resistor circuit 514 and currents of devices 516 and 518, and based further on random process variations of capacitor circuit 510, switch circuit 512, resistor circuit 514, and devices 516 and 518.

Capacitor circuit 510 and/or resistor circuit 514 may be configurable and/or may be splintered/distributed amongst multiple regions (e.g., layers, levels, and/or locations) of one or more integrated circuit dies, examples of which are provided below.

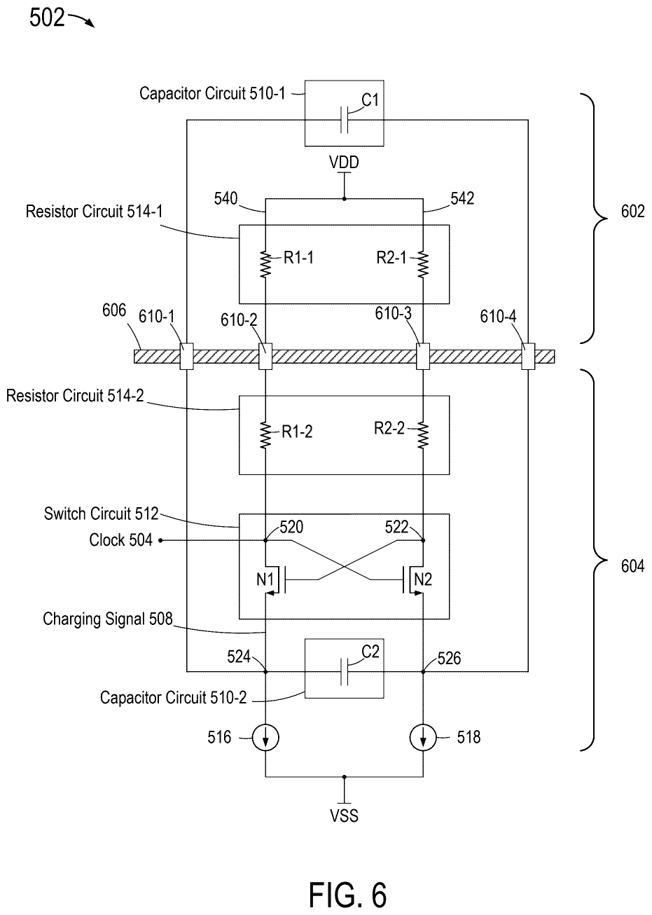

FIG. 6 depicts a splintered implementation of differential relaxation oscillator circuit 502, according to an embodiment. In the example of FIG. 6, capacitor circuit 510 includes a capacitor circuit 510-1 within a first region 602, and a capacitor circuit 510-2 within a second region 604. In this example, capacitor circuits 510-1 and 510-2 are in parallel with one another. Further in FIG. 6, resistor circuit R1 includes a resistor R1-1 within first region 602, and a resistor R1-2 within second region 604. In this example, resistors R1-1 and R1-2 are in series with one another. Similarly, resistor circuit R2 includes a resistor R2-1 within first region 602, and a resistor R2-2 within second region 604.

In an example, regions 602 represents an upper-most layer (i.e., a top layer) of a first die, and region 604 represents a lower-most layer (i.e., bottom layer) of a second die. Regions 602 and 604 may be separated by a layer 606, which may represent or include a layer of a dielectric material, an interposer, and/or a metal layer, and which may include metal-filled vias 610 that connect circuitry of regions 602 and 604. Regions 602, 604, and layer 606 are not limited to the foregoing examples. In another example, regions 602 and 604 represent respective first and second dies, and layer 606 represents an interposer.

Splintering differential relaxation oscillator circuit 502 amongst multiple regions (e.g., layers, levels, and/or locations) of one or more dies may be useful to incorporate additional sources of entropy/randomness in the frequency of clock 504. Splintering differential relaxation oscillator circuit 502 amongst multiple dies may useful to provide clocks for the dies. Placing capacitor circuit 510-1 and/or resistor circuit 514-1 in an upper-most layer, and/or placing capacitor circuit 510-2 and/or resistor circuit 514-2 in a lower-most layer may enhance security in that removing the upper-most layer and/or the lower-most layer (i.e., for malicious purposes) may disable the relaxation oscillator circuit and/or invalidate the entropy generation functionality. Splintering differential relaxation oscillator circuit 502 may also be useful to reduce design/manufacturing costs. As an example, splintering differential relaxation oscillator circuit 502 may reduce costs of a heterogeneous die stack implementation in which resistors and/or capacitors in the upper-most die (i.e., region 602) are implemented with passive circuitry/devices in metal layers rather than with active devices.

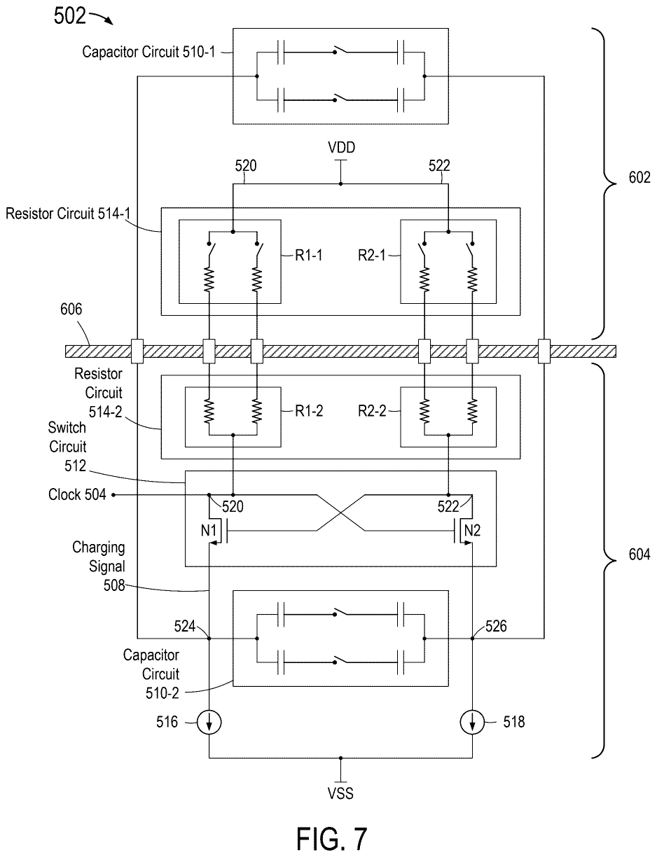

FIG. 7 depicts a splintered implementation of differential relaxation oscillator circuit 502, according to another embodiment. In the example of FIG. 7, capacitor circuits 510-1 and 510-2 include multiple selectable parallel branches of series-coupled capacitors, and resistor circuits R1 and R2 include multiple selectable branches of series-coupled resistors. Each selectable branch includes multiple series-coupled resistors distributed amongst regions 602 and 604. Selectable branches of capacitors and/or resistors may be useful to determine stability of pairs of relaxation oscillators over a range of frequencies/phases (i.e., to ensure that bit values generated from pairs of clocks 104 in FIG. 4, are consistent over a range of frequencies/phases). Selectable branches of capacitors and/or resistors may also be useful to permit a user to alter the frequency and/or phase of clock 504 (e.g., to alter signature 404).

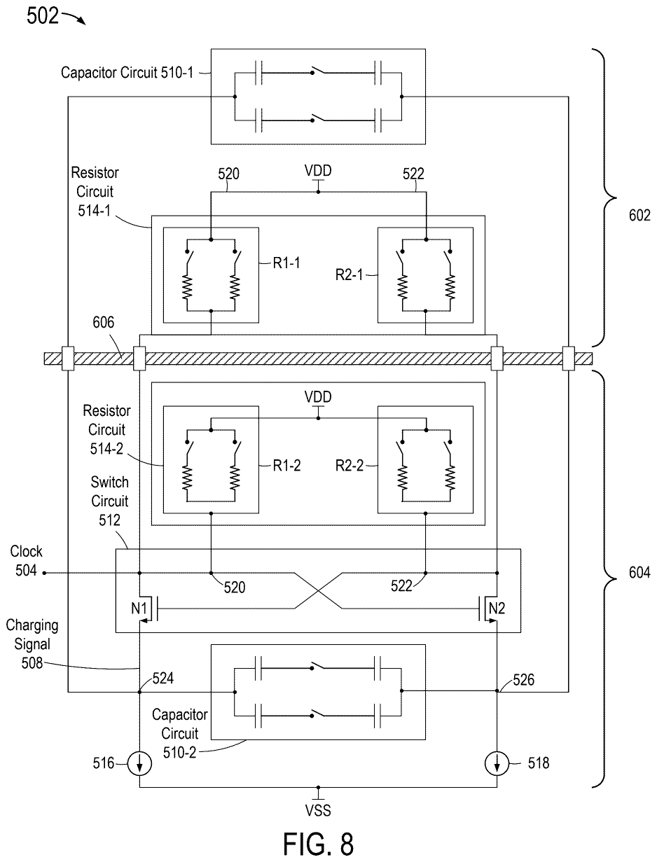

FIG. 8 depicts a splintered implementation of differential relaxation oscillator circuit 502, according to another embodiment. In the example of FIG. 8, resistor circuits R1-1 and R1-2 are in parallel with one another, and resistor circuits R1-1 and R1-2 each include multiple selectable branches of resistors.

Series-coupled resistors, such as depicted in FIG. 7, may be useful to increase security (i.e., inoperable when top die is removed). Parallel resistors, such as depicted in FIG. 8, may provide enhanced programmability, avoid non-linearity issues, provide larger parasitic area, and/or ease matching.

Differential relaxation oscillator circuit 502 may include various combinations of features described above with reference to FIGS. 6 through 8.

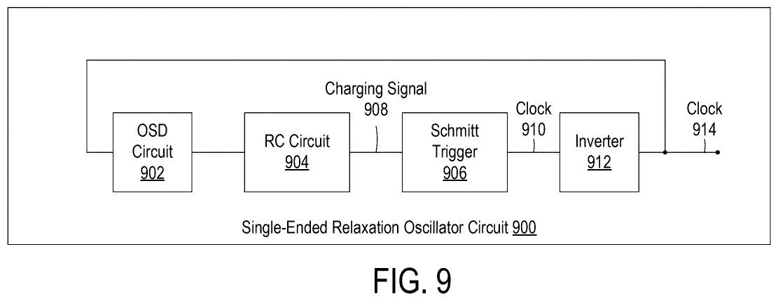

FIG. 9 depicts a single-ended relaxation oscillator circuit 900, according to an embodiment. Single-ended relaxation oscillator circuit 900 may represent an example embodiment of relaxation oscillator circuit 102. Relaxation oscillator circuit 102 is not, however, limited to the example of FIG. 9.

In the example of FIG. 9, single-ended relaxation oscillator circuit 900 includes an oscillator select (OS)/enable and discharge (OSD) circuit 902, a resistive/capacitive (RC) circuit 904 that generates a charging signal 908 based on power received from OSD circuit 902, a Schmitt trigger circuit 906 that generates a clock 910 based on charging signal 908, and an inverter 912 that inverts clock 910 to provide a clock 914. As described further below, Schmitt trigger circuit 906 performs reference generation and comparison operations (i.e., without an explicit reference voltage), and provides wide pulses and good duty cycle (e.g., a square wave rather than narrow pulses/impulses).

The frequency of clock 914 is based on a RC constant of RC circuit 904, and random process variations of elements of single-ended relaxation oscillator circuit 900. Example embodiments of single-ended relaxation oscillator circuit 900 are provided below. Single-ended relaxation oscillator circuit 900 is not limited to the following examples.

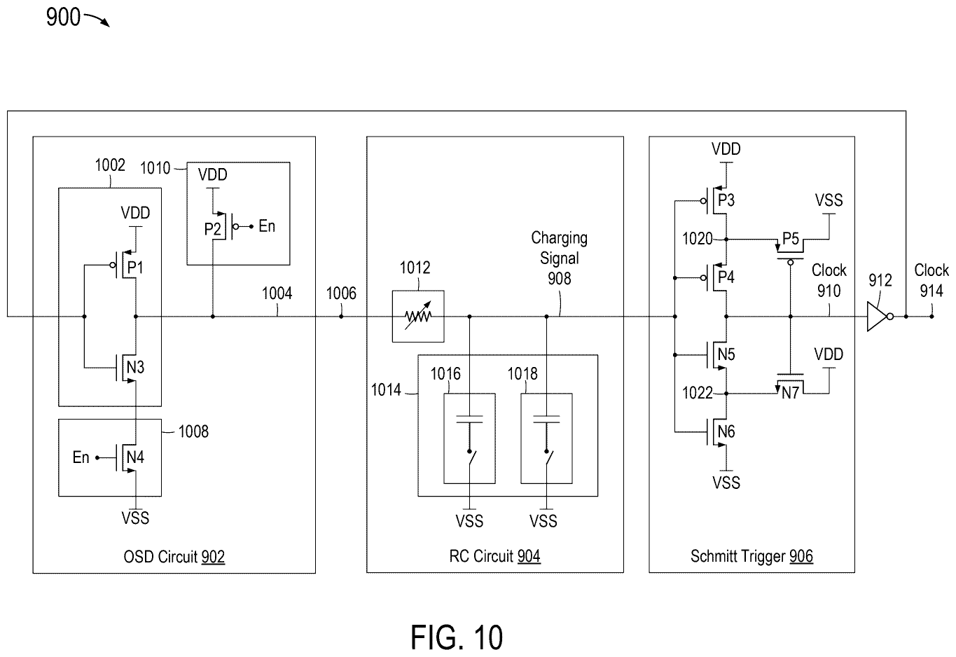

FIG. 10 depicts single-ended relaxation oscillator circuit 900, according to an embodiment. In the example of FIG. 10, OSD circuit 902 includes an inverter 1002 that inverts clock 914 to provide an inverted clock 1004 at an output node 1006. OSD circuit 902 may further include an enable circuit 1008 that selectively enables/disables inverter circuit. OSD circuit 902 may further include a pull-up circuit 1010 that pulls up output node 1006 when inverter 1002 is disabled. Pull-up circuit 1010 may be useful to keep output node 1006 at stable voltage in off states.

Further in FIG. 10, RC circuit 904 includes a resistor circuit 1012 and a capacitor circuit 1014 that generate charging signal 908 based on inverted clock 1004 at output node 1006. Resistor circuit 1012 may include a single fixed-value resistor, multiple selectable resistor circuits (e.g., parallel and/or series resistor circuits), and/or or a variable resistor as depicted in FIG. 10. Capacitor circuit 1014 may include a single fixed-value capacitor, a variable capacitor, and/or multiple selectable capacitor circuits. In the example of FIG. 10, capacitor circuit 1014 includes multiple parallel capacitor circuits 1016 and 1018. Capacitor circuit 1014 may include more than two multiple parallel branches of selectable capacitor circuits.

In FIG. 10, Schmitt trigger circuit 906 includes P-type transistors P3, P4 and P5, and N-type transistors N5, N6, and N7. Transistors P3 and P5 may serve as a voltage divider to control a voltage at a node 1020. N6 and N7 may serve as a voltage divider to control a voltage at a node 1022. The voltage dividers may determine upper and lower thresholds (e.g., upper and lower thresholds 302 and 304 of FIG. 3).

FIG. 10 is further described below with reference to FIGS. 2 and 3. When power is applied to single-ended relaxation oscillator circuit 900 (e.g., at time 204 in FIGS. 2 and 3), charging signal 908 may initially be low (i.e., at VSS). The low state of charging signal 908 enables transistors P3 and P4, and disables transistors N5 and N6. In this state, clock 910 is pulled-up to the voltage of node 1020 via transistors P4, which disables transistors P5 and enables transistors N7. When clock 910 is pulled up, inverter 912 pulls down clock 914 towards VSS (e.g., at time 204 in FIGS. 2 and 3), and PS and discharge circuit pulls up output node 1006.

When output node 1006 is pulled up, capacitor circuit 1014 begins charging. Over time (e.g., time 206 in FIGS. 2 and 3), clock 914 remains low as capacitor circuit 104 charges. When the charge of capacitor circuit 1014 reaches the upper threshold (e.g., upper threshold 302), transistors P3 and P4 turn off, and transistors N5 and N6 turn on. In this state, clock 910 is pulled down towards the voltage at node 1022 via transistor N5, which disables transistor N7 and enables transistor P5. When clock 910 is pulled down, inverter 912 pulls up clock 914 (e.g., at time 208 in FIGS. 2 and 3), and inverter 1002 pulls down inverted clock 1004 at output node 1006.

When output node 1006 is pulled down, charging signal 908 is pulled down and capacitor circuit 1014 discharges. As described further above, the low state of charging signal 908 enables transistors P3 and P4 and disables transistors N5 and N6 and. In this state, clock 910 is pulled up toward the voltage at node 1020 via transistor P4, which disables transistor P5 and enables transistor N7. When clock 910 is pulled up, inverter 912 pulls down clock 914 towards VSS (e.g., at time 212 in FIGS. 2 and 3), and OSD circuit 902 pulls up output node 1006. When output node 1006 is pulled up, capacitor circuit 1014 begins charging again. The foregoing process repeats as long as enable circuit 1008 is enabled and pull-up circuit 1010 is disabled. The frequency of clock 914 is determined by an RC constant and random process variations of RC circuit 904.

Capacitor circuit 1014 and/or resistor circuit 1012 may be splintered/distributed amongst multiple layers/levels of an integrated circuit die and/or amongst multiple dies of a multi-die device, examples of which are provided below.

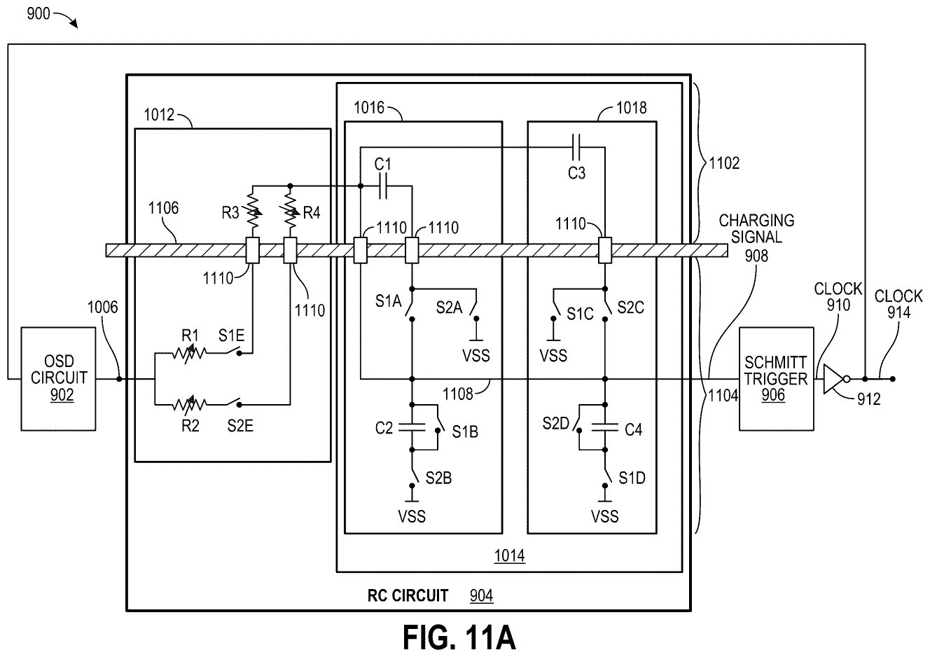

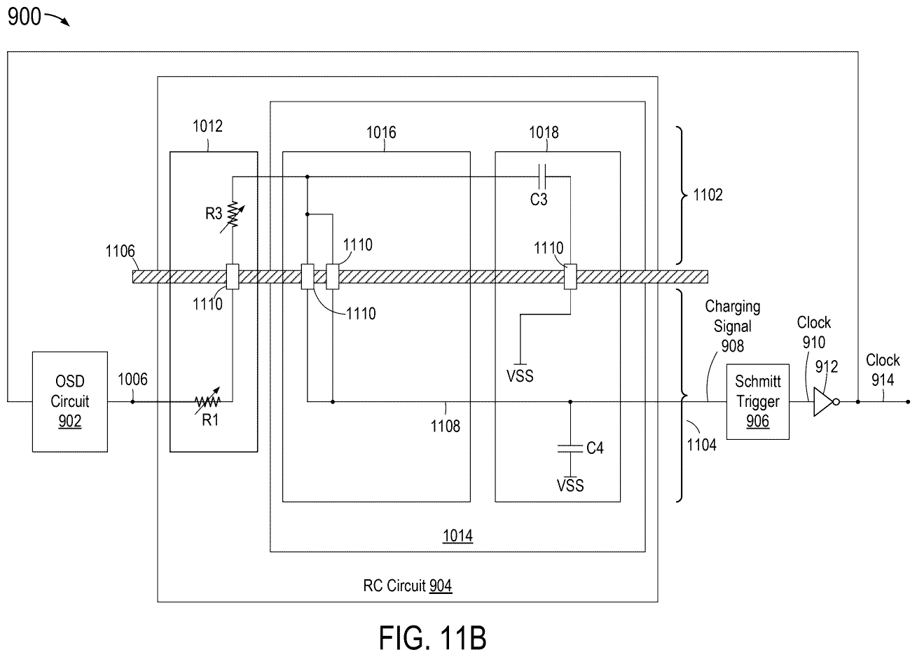

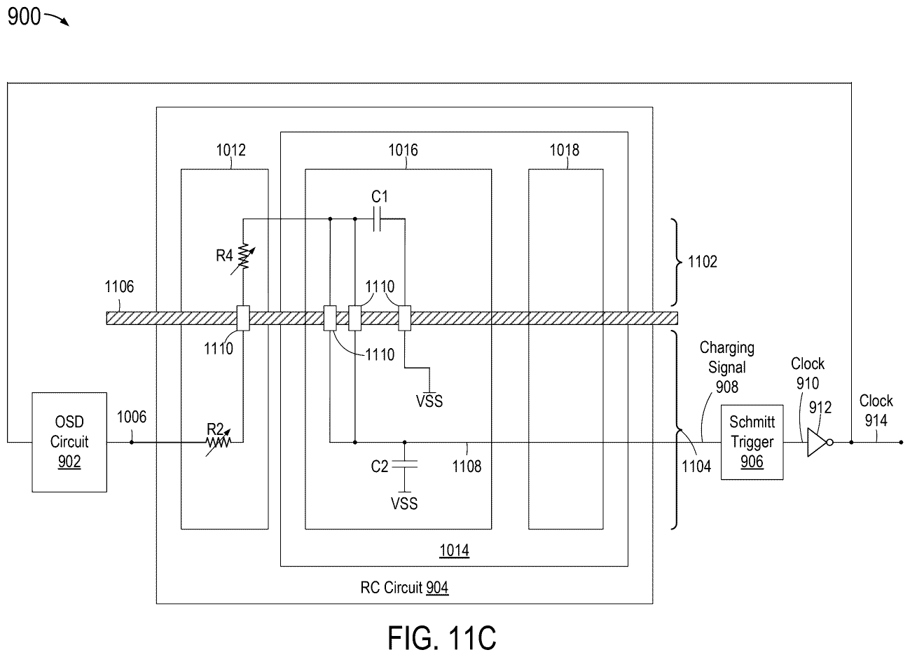

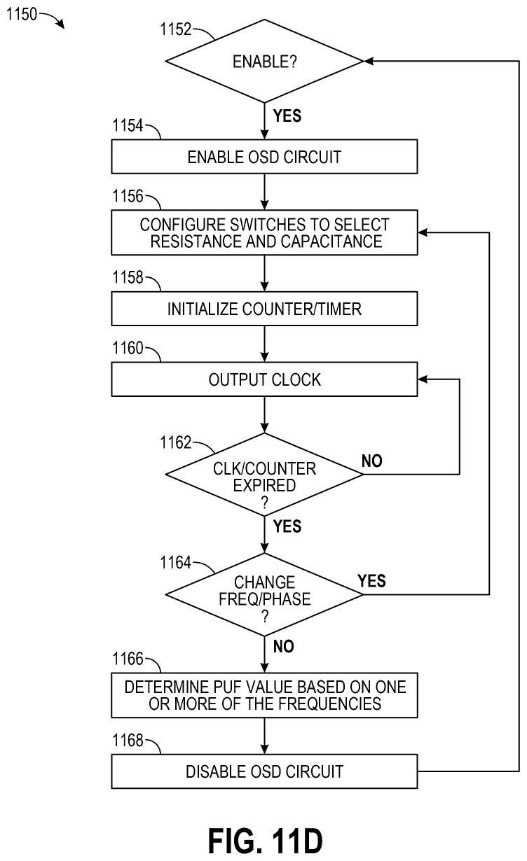

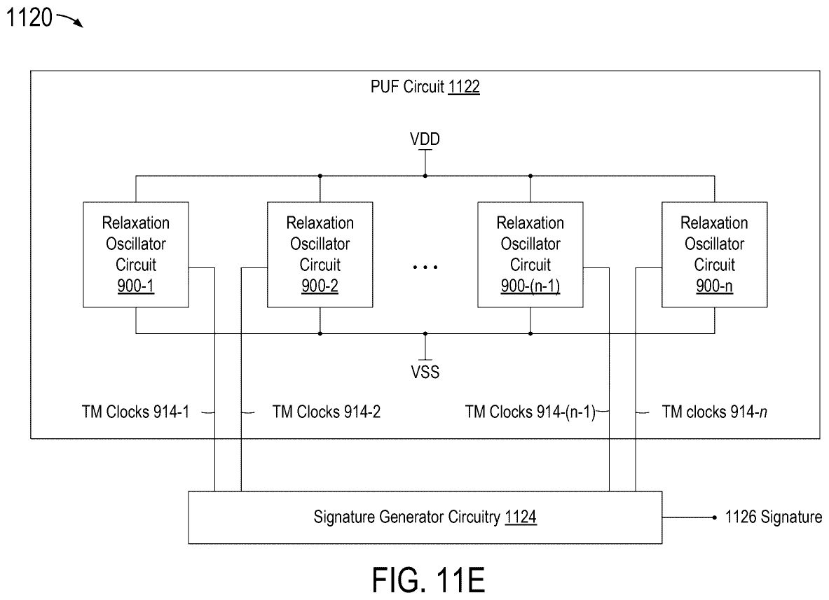

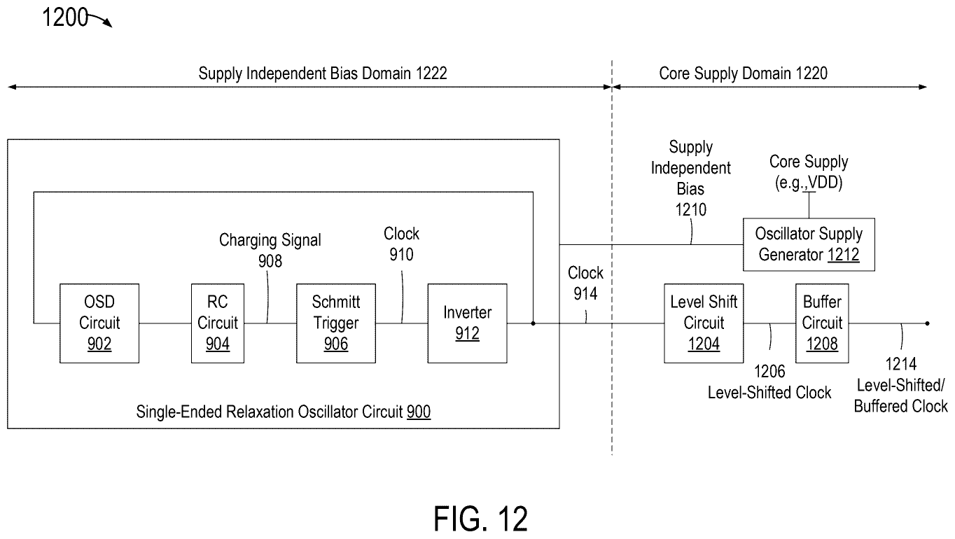

FIG. 11A depicts a splintered/distributed implementation of single-ended relaxation oscillator circuit 900, according to an embodiment. In the example of FIG. 11A, capacitor circuit 1016 includes a capacitor C1 within a first region 1102 and a capacitor C2 within a second region 1104. Capacitor circuit 1018 includes a capacitor C3 within first region 1102 and a capacitor C4 within second region 1104. One or more of capacitors C1, C2, C3, and C4 may represent an adjustable capacitor circuit (e.g., a bank of selectable capacitors). Further in FIG. 11A, resistor circuit 1012 includes a resistors R1 and R2 within the second region 1104, and resistors R3 and R4 within first region 1102. One or more of resistors R1, R2, R3, and R4 may represent an adjustable resistor circuit (e.g., a bank of selectable resistors).

Region 1102 may represent a first die (e.g., an upper-most layer of a first die), and region 1104 may represent a die (e.g., a lower-most layer of a second die), of a multiple-die device. Regions 1102 and 1104 may be separated by a layer 1106, which may represent or include a layer of a dielectric material, an interposer, a metal layer, and which may include metal-filled vias 1110 that connect circuitry of regions 1102 and 1104. Regions 1102, 1104, and layer 1106 are not limited to the foregoing examples. In another example, regions 1102 and 1104 represent respective first and second dies, and layer 1106 represents an interposer.

Splintering single-ended relaxation oscillator circuit 900 amongst multiple dies may be useful to incorporate additional sources of entropy/randomness in the frequency of clock 914. Splintering single-ended relaxation oscillator circuit 900 amongst multiple dies may also useful to provide clocks for the dies. Splintering single-ended relaxation oscillator circuit 900 amongst an upper-most die and a lower-most die may also enhance security in that tampering with one of the dies (e.g., delaying or removing the upper-or the lower-most die (i.e., for malicious purposes), may disable relaxation oscillator circuit 900 and/or alter the entropy generation functionality of relaxation oscillator circuit 900.

In the example of FIG. 11A, capacitor circuit 1016 further includes switches S1A, S1B, S2A, and S2B within second region 1104, capacitor circuit 1018 further includes switches S1C, S1D, S2C, and S2D, and resistor circuit 1012 further includes switches S1E, and S2E. Switches S1A, S1B, S1C, S1D, and S1E (collectively, switches S1), and switches S2A, S2B, S2C, S2D, and S2E (collectively, switches S2), may be controlled to enable and/or bypass various combinations of resistors R1, R2, R3, and R4, and capacitors C1, C2, C3, and C4. Examples are provided below with reference to FIGS. 11B and 11C. Control of switches S1 and S2 are not, however, limited to the examples of FIGS. 11B and 11C.

FIG. 11B depicts an equivalent schematic of the splintered/distributed single-ended relaxation oscillator circuit of FIG. 11A when switches S1 are closed and switches S2 are open. In the example of FIG. 11B, capacitors C3 and C4 are coupled between node 1108 and VSS, in parallel with one another, and resistors R1 and R3 are coupled in series.

FIG. 11C depicts an equivalent schematic of the splintered/distributed single-ended relaxation oscillator circuit of FIG. 11A when switches S1 are open and switches S2 are closed, according to an embodiment. In the example of FIG. 11C, capacitors C1 and C2 are coupled between node 1108 and VSS, in parallel with one another, and resistors R2 and R4 are coupled in series. In the examples of FIGS. 11B and 11C, a capacitor from each of regions 1102 and 1104 is enabled, in parallel with one another, and a resistor from each of regions 1102 and 1104 is enabled, in series with one another. Further in the examples of FIGS. 11B and 11C, resistor circuit 1012 is controlled such that resistors R1 and R3 form a first selectable set of series-coupled resistors, and resistors R2 and R4 form a second selectable set of series-coupled resistors, where the first and second selectable sets are in parallel with one another. The examples of FIGS. 11B and 11C may be useful for generating time-multiplexed (TM) clocks, such as described below with reference to FIG. 11D.

FIG. 11D depicts a method 1150 of generating a clock having time-multiplexed frequencies, according to an embodiment. Method 1150 is described below with reference to the splintered/distributed embodiment of single-ended relaxation oscillator circuit 900, as depicted in FIGS. 11A, 11B, and 11C. Method 1150 is not, however, limited to the examples of FIGS. 11A, 11B, or 11C.

At 1152, when the splintered/distributed embodiment of single-ended relaxation oscillator circuit 900 is to be operated, processing proceeds to 1154.

At 1154, OSD circuit 902 is enabled.

At 1156, switches S1 and S2 are controlled to select a resistance and a capacitance. In a first iteration, switches S1 may be closed and switches S2 may be opened, such as described above with reference to FIG. 11B.

At 1158, a counter or timer is initialized.

At 1160, the splintered/distributed single-ended relaxation oscillator circuit of FIG. 11B generates clock 914 having a first frequency that is based on the resistance and capacitance selected at 1156, and random process variations of elements of the splintered/distributed embodiment of single-ended relaxation oscillator circuit 900.

At 1162, when the counter or timer reaches a desired count or time (i.e., when the counter/time expires), processing proceeds to 1166.

At 1164, if another frequency for the same phase or different phase is desired, processing returns to 1156 for a subsequent iteration. In the subsequent iteration, switches S1 may be opened and switches S2 may be closed, such as described above with reference to FIG. 11C. In the subsequent iteration, the frequency of clock 914 depends on the resistance and capacitance selected at 1156 for the subsequent iteration, and the random process variations of elements of the splintered/distributed embodiment of single-ended relaxation oscillator circuit 900. Where resistor circuits R1 and R3 and capacitor circuit C3 and C4 are designed to be identical to respective one of resistor circuits R2 and R4 and capacitor circuit C1 and C2. Where one or more of resistor circuits R1, R2, R3, and/or R4 is variable, the resistance of the resistor circuit(s) may be varied to provide a greater frequency shift.

At 1166, a signature generator circuit may determine a PUF value based on one or more time-multiplexed frequencies of clock 914, such as described further below with reference to FIG. 11E.

When no further time-multiplexed frequencies are desired, processing proceeds to 1168, where OSD circuit 902 is disabled. Processing may return to 1152.

A time-division multiplexed clock may be useful to determine a unique signature, such as described below with reference to FIG. 11E. FIG. 11E depicts a system 1120 that includes a PUF circuit 1122, with n splintered/distributed single-ended relaxation oscillator circuits 900-1 through 900-n, according to an embodiment. Splintered/distributed single-ended relaxation oscillator circuits 900-1 through 900-ngenerate respective time-multiplexed (TM) clocks 914-1 through 914-n (collectively, TM clocks 914). TM clocks 914 may have two or more time-multiplexed frequencies, such as described above with reference to FIGS. 11B, 11C, and 11D. System 1120 further includes signature generator circuitry 1124 that determines a value or state (e.g., a binary value/state) for each of TM clocks 914-1 through 914-n. In an example, TM clocks 914-1 include first and second time-division multiplexed frequencies, and signature generator circuitry 1124 determines a binary value 1 or 0 depending on which of the first and second frequencies is highest. In another example, TM clocks 914-1 include more than two time-division multiplexed frequencies, and signature generator circuitry 1124 determines a value based on comparison of two or more groups of the frequencies.

In the examples of FIGS. 11A through 11E, resistor circuit 1012 and capacitor circuits 1016 and 1018 are distributed over multiple regions (e.g., dies), and are selectable in groups by switches S1 and S2. In another example, capacitor circuits 1016 and 1018 and resistor circuit 1012 (e.g., resistors R1, R2, R3, and R4) are distributed over multiple regions (e.g., dies), and are individually selectable.

A relaxation oscillator circuit, as disclosed herein, may operate based on a supply-independent bias, such as described below. FIG. 12 depicts a system 1200 that includes single-ended relaxation oscillator circuit 900, according to an embodiment. In FIG. 12, single-ended relaxation oscillator circuit 900 operates based on a supply-independent bias 1210 (e.g., a current generated from a core supply generator 1212) of a core supply domain 1220. In this example, single-ended relaxation oscillator circuit 900 operates in a supply independent bias domain 1222.

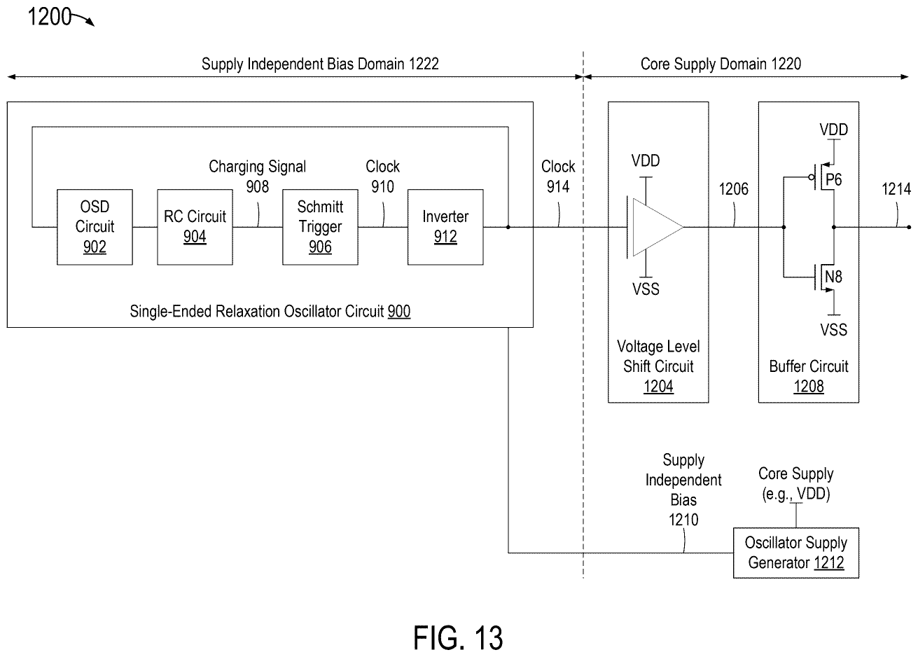

System 1200 may further include a voltage level shift circuit 1204 that level-shifts clock 914 from a voltage swing of supply independent bias domain 1222 to a voltage swing of core supply domain 1220, to provide a level-shifted clock 1206. In this example, inverter 912 may further serve to isolate Schmitt trigger circuit 906 from switching noise of voltage level shift circuit 1204. System 1200 may further include a buffer circuit 1208 that buffers level-shifted clock 1206 to provide a level-shifted buffered clock 1214. Where voltage level shift circuit 1204 inverts clock 914, buffer circuit 1808 may include an inverter. FIG. 13 depicts system 1200, according to an embodiment. In FIG. 13, buffer circuit 1208 includes a P-type transistor P6, and a N-type transistor, N8, configured as an inverter.

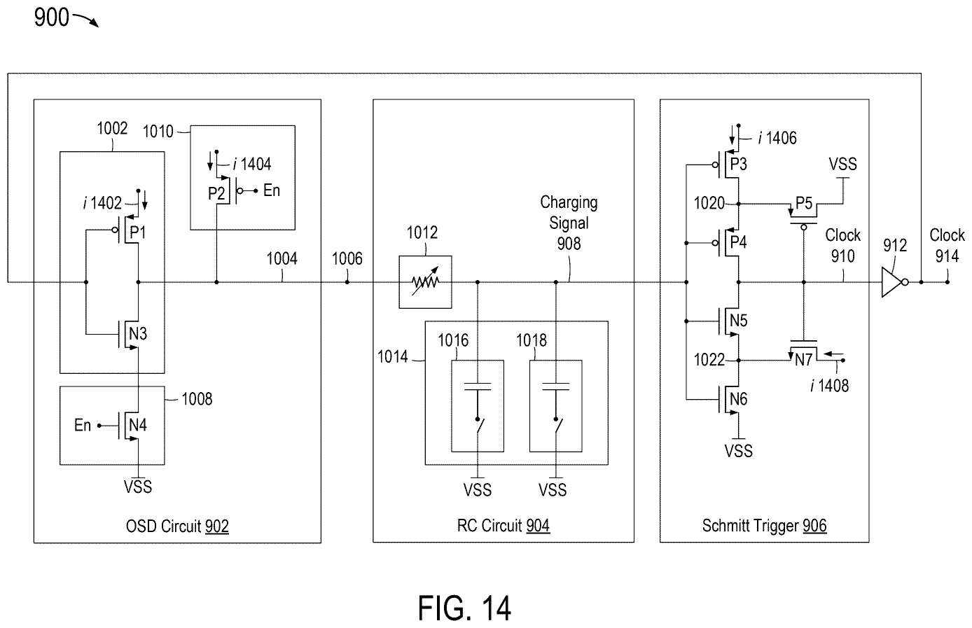

FIG. 14 depicts single-ended relaxation oscillator circuit 900 operating on supply-independent bias 1210, according to an embodiment. In the example of FIG. 14, transistor P1 of OSD circuit 902 receives a current 1402 rather than VDD, and transistor P2 receives a current 1404 rather than VDD. Transistor P3 of Schmitt trigger circuit 906 receives a current 1406 rather than VDD, and transistor N7 receives a current 1408 rather than VDD. Currents 1402 through 1408 may be sourced from the same current source.

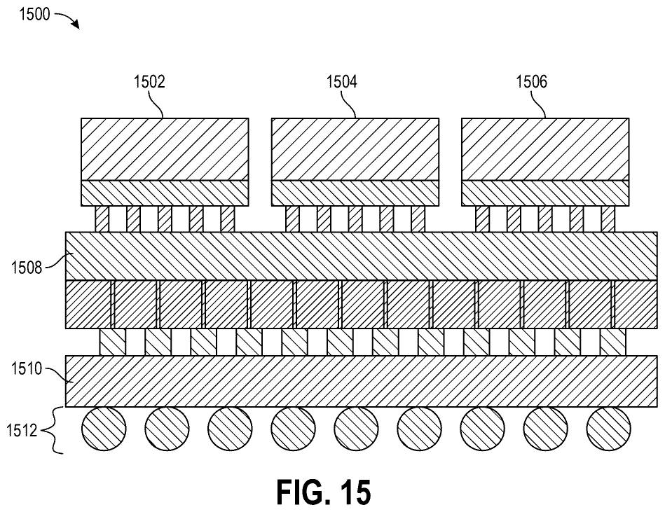

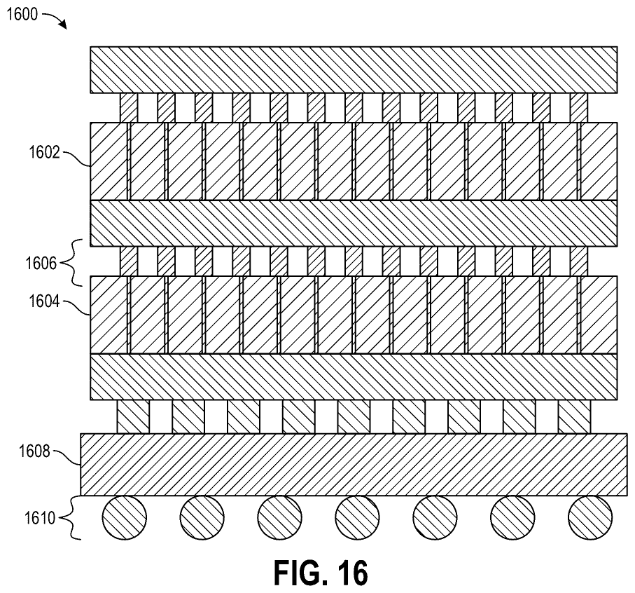

FIG. 15 depicts a multi-die integrated circuit device (device) 1500 in which a PUF circuit, as disclosed herein, may be implemented. In the example of FIG. 15, device 1500 includes dies 1502, 1504, and 1506, interconnected with one another via an interposer 1508, which may be mounted on a package substrate 1510. Package substrate 1510 may include external pads 1512 (e.g., solder bumps) to provide electrical connections between metal-filled vias of package substrate 1510 and one or more devices (e.g., via a printed circuit board). Device 1500 may be referred to as a 2.5-dimensional (2.5D) device. A PUF circuit, as disclosed herein, may be distributed amongst two or more of dies 1502, 1504, and 1506 (e.g., upper and/or lower layers/levels of two or more of dies 1502, 1504, and 1506).

FIG. 16 depicts a multi-die integrated circuit device (device) 1600 in which a PUF circuit, as disclosed herein, may be implemented. In the example of FIG. 16, device 1600 includes dies 1602 and 1604, interconnected with metal-filed vias 1606, which may include through-silicon vias (TSVs). Device 1600 further includes a package substrate 1608 having external pads 1601 (e.g., solder bumps) to provide electrical connections between metal-filled vias of package substrate 1608 and one or more other devices (e.g., via a printed circuit board). One or more of dies 1602 and 1604 may communicate with the one or more external devices via package substrate 43 1608. In the example of FIG. 16, dies 1602 and 1604 are arranged as 3-dimensional (3D) stack. A PUF circuit, as disclosed herein, may be distributed amongst dies 1602 and 1604 (e.g., an upper-most layer/level of die 1602, and a lower-most layer/level of die 1604).

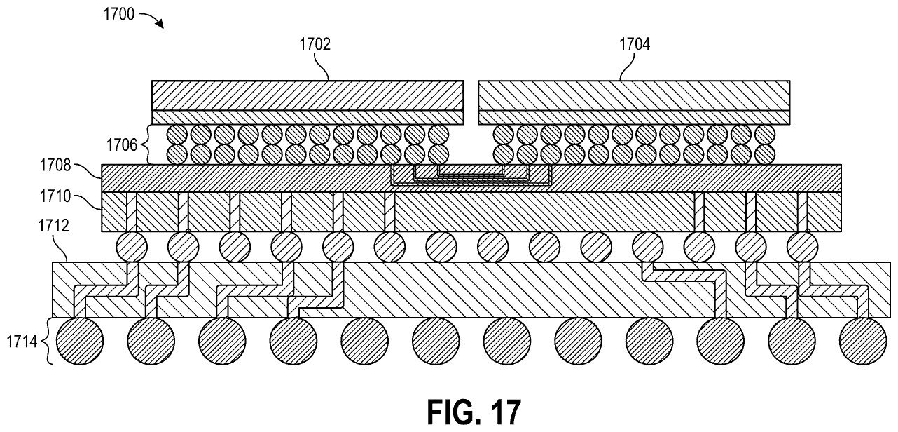

FIG. 17 depicts a multi-die integrated circuit device (device) 1700 in which a PUF circuit, as disclosed herein, may be implemented. In the example of FIG. 17, device 1700 includes dies 1702 and 1704. In an example, die 1702 is a memory device, which may include a stack of memory dies arranged as a high-bandwidth memory (HBM) device, and die 1702 includes a processor, memory, and one or more other blocks of circuitry, which may be arranged as a system-on-chip (SoC). In the example of FIG. 17, dies 1702 and 1704 communicate with one another via external pads 1706 (e.g., micro-bumps and/or hybrid bonds) and a wiring substrate 1708. Device 1700 may further include a package substrate 1714 having external pads 1714 (e.g., solder bumps) to provide electrical connections between metal-filled vias of package substrate 1712 and one or more other devices (e.g., via a printed circuit board). Device 1700 may further include an interposer 1708 to provide electrical connections between the metal-filled vias of package substrate 1712 and one or more of dies 1702 and 1704 (i.e., via wiring substrate 1708). A PUF circuit, as disclosed herein, may be distributed amongst dies 1702 and 1704 (e.g., an upper-most and/or a lower-most layer/level of die 1702 and/or die 1704).

Circuit topologies of examples provided herein can be flipped (i.e., reversed or inverted) to take advantage of complimentary MOS process technology. As an example, circuit components depicted in a top-die can be placed in a bottom die in the corresponding complementary circuit implementation, and vice versa.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An integrated circuit device, comprising:
a physical unclonable function (PUF) circuit comprising a relaxation oscillator circuit configured to generate a clock signal having a frequency that is based in part on random process variations of the PUF circuit, wherein at least a portion of the relaxation oscillator circuit is distributed amongst multiple dies of the integrated circuit device.

2. The integrated circuit device of claim 1, wherein the relaxation oscillator circuit comprises a differential relaxation oscillator circuit.

3. The integrated circuit device of claim 2, wherein the differential relaxation oscillator circuit comprises:
a capacitor circuit;
a switch circuit configured to charge the capacitor circuit, discharge the capacitor circuit when a charge of the capacitor meets a threshold, and generate the clock signal based on charge/discharge cycles of the capacitor circuit; and
a resistor circuit configured to provide power to the switch circuit;
wherein the frequency of the clock signal is based on a resistance of the resistor circuit, a capacitance of the capacitor circuit, and random process variations of the capacitor circuit, the switch circuit, and the resistor circuit.

4. The integrated circuit device of claim 3, wherein:
one or more of the capacitor circuit and the resistor circuit is distributed amongst the multiple dies of the integrated circuit device.

5. The integrated circuit device of claim 3, wherein:
the switch circuit comprises first and second transistors in a cross-coupled configuration such that when one of the first and second transistors is on, the other one of the first and second transistors is off due to contention between the first and second transistors;
the resistor circuit comprises first and second resistor circuits, each coupled between a supply voltage node and a respective one of the first and second transistors; and
the capacitor circuit is coupled to the first and second transistors, and is configured to reduce the contention and change states of the first and second transistors when the charge of the capacitor meets the threshold.

6. The integrated circuit device of claim 5, wherein:
the first and second resistor circuits each comprise multiple selectable resistor circuits.

7. The integrated circuit device of claim 5, wherein:
the first resistor circuit comprises a bank of selectable resistor circuits in parallel with one another;
a first one of the selectable resistor circuits comprises first and second resistors in series with one another;
first resistor is placed in a first die of the integrated circuit device; and
the second resistor is placed in a second die of the integrated circuit device.

8. The integrated circuit device of claim 5, wherein:
the first resistor circuit comprises first and second banks of selectable resistors in parallel with one another;
first bank of selectable resistors is placed in a first die of the integrated circuit device; and
the second bank of selectable resistors is placed in a second die of the integrated circuit device.

9. The integrated circuit device of claim 5, wherein:
the capacitor circuit comprise multiple selectable capacitor circuits in parallel with one another.

10. The integrated circuit device of claim 5, wherein:
the capacitor circuit comprises first and second capacitor circuits in parallel with one another;
the first capacitor circuit is placed in a first die of the integrated circuit device; and
the second capacitor circuit is placed in a second die of the integrated circuit device.

11. The integrated circuit device of claim 10, wherein:
the first capacitor circuit comprises a bank of selectable capacitor circuits in parallel with one another; and
the second capacitor circuit comprises a bank of selectable capacitor circuits in parallel with one another.

12. The integrated circuit device of claim 1, wherein the relaxation oscillator circuit comprises a single-ended relaxation oscillator circuit that comprises:
a resistive/capacitive (RC) circuit configured to generate a charging signal;
a Schmitt trigger configured to generate an internal clock based on the charging signal;
an inverter configured to output the clock signal based on the internal clock; and
an oscillator select and discharge circuit configured to charge and discharge the RC circuit based on the clock signal.

13. The integrated circuit device of claim 12, wherein:
the RC circuit comprises multiple selectable capacitor circuits in parallel with one another.

14. The integrated circuit device of claim 13, wherein:
a first one of the selectable capacitor circuits comprises first and second capacitors in parallel with one another;
the first capacitor is placed in a first die of the integrated circuit device; and
the second capacitor is placed in a second die of the integrated circuit device.

15. The integrated circuit device of claim 12, wherein:
the RC circuit comprises multiple selectable resistors circuits in parallel with one another;
the first resistor circuit comprises a first resistor placed in a first die of the integrated circuit device and a second resistor placed in a second die of the integrated circuit device, wherein the first and second resistors are coupled in series with one another; and
the second resistor circuit comprises a third resistor placed in a first die of the integrated circuit device and a fourth resistor placed in a second die of the integrated circuit device, wherein the third and fourth resistors are coupled in series with one another.

16. The integrated circuit device of claim 15, wherein one or more of the first, second, third, and fourth resistor comprises a bank of selectable resistors.

17. The integrated circuit device of claim 12, further comprising:
a current source configured to isolate the single-ended relaxation oscillator circuit from variations in a supply voltage of the integrated circuit device.

18. An integrated circuit device, comprising:
a clock generator circuit comprising a relaxation oscillator circuit configured to generate a clock signal, wherein the relaxation oscillator circuit comprises a resistor circuit and a capacitor circuit, and wherein one or more of the resistor circuit and the capacitor circuit is distributed amongst multiple dies the integrated circuit device.

19. The integrated circuit device of claim 18, wherein:
the relaxation oscillator circuit comprises a differential relaxation oscillator circuit.

20. The integrated circuit device of claim 18, wherein:
the relaxation oscillator circuit comprises a single-ended relaxation oscillator circuit.

21. The integrated circuit device of claim 18, wherein the relaxation oscillator circuit is configurable to generate the clock signal with one or more of time-multiplexed frequencies.

22. The integrated circuit device of claim 21, wherein:
the capacitor circuit comprises multiple capacitors distributed amongst first and second ones of the dies, and switches placed in the first die to selectively enable multiple combinations of the capacitors; and
switch control circuitry configured to periodically reconfigure the switches to generate the clock signal with the one or more of the time-multiplexed frequencies.

23. The integrated circuit device of claim 21, wherein:
the resistor circuit comprises multiple resistors distributed amongst first and second ones of the dies, and switches placed in the first die to selectively enable multiple combinations of the resistors; and
switch control circuitry configured to periodically reconfigure the switches to generate the clock signal with the one or more of the time-multiplexed frequencies.

24. A method, comprising:
enabling a clock generator circuit that comprises a relaxation oscillator circuit in a first one of multiple dies of an integrated circuit device, and a resistive/capacitive (RC) circuit distributed amongst the multiple dies, wherein the RC circuit is configurable in first and second configurations to provide respective first and second RC time constants; and
configuring the RC circuit in the first configuration for a first period of time and configuring the RC circuit in the second configuration for a second period of time such that the clock generator circuit generates first and second time-multiplexed clocks having frequencies that are based in part on the respective first and second RC time constants.

25. The method of claim 24, wherein the frequencies of the first and second time-multiplexed clocks are based further on random process variations of the clock generator circuit, the method further comprising:
determining a first bit value based on the first and second time-multiplexed clocks;
determining additional bit values based on time-multiplexed clocks generated by additional clock generator circuits of the integrated circuit device; and
generating a signature that is unique to the integrated circuit device based on the first bit value and the additional bit values.

26. The method of claim 24, wherein the RC circuit comprises multiple capacitors in each of the first die and a second one of the dies, and switches in the first die to selectively enable multiple combinations of the capacitors, and wherein:
the configuring the RC circuit in the first configuration for the first period of time comprises enabling a first set of the capacitors for the first period of time; and
the configuring the RC circuit in the second configuration for the second period of time comprises enabling a second set of the capacitors for the second period of time;
wherein the first and second sets of capacitors each comprises at least one of the capacitors of the first die and at least one of the capacitors of the second die.

27. The method of claim 24, wherein the RC circuit comprises multiple resistors in each of the first die and a second one of the dies, and switches in the first die to selectively enable multiple combinations of the resistors, and wherein:
the configuring the RC circuit in the first configuration for the first period of time comprises enabling a first set of the resistors for the first period of time; and
the configuring the RC circuit in the second configuration for the second period of time comprises enabling a second set of the resistors for the second period of time;
wherein the first and second sets of resistors each comprises at least one of the resistors of the first die and at least one of the resistors of the second die.
